(19) United States
(12) Patent Application Publication
(10) Pub. No.: US 2025/0158422 A1
(43) Pub. Date: May 15, 2025

(54) METHOD FOR CHARGING AN ENERGY SUPPLY DEVICE, AND SYSTEM COMPRISING AN ENERGY SUPPLY DEVICE AND A CHARGING DEVICE

(71) Applicant: Hilti Aktiengesellschaft, Schaan (LI)

(72) Inventors: Stefan MAYER, Fensterbach (DE); David KOSCHECK, Landsberg (DE); Klaus HAUSER, Schwabmuenchen (DE)

(21) Appl. No.: 18/722,608

(22) PCT Filed: Jan. 2, 2023
(86) PCT No.: PCT/EP2023/050023

§ 371 Date: Jun. 21, 2024

(30) Foreign Application Priority Data
Jan. 11, 2022 (EP) 22150839.3

(51) Int. Cl. H02J 7/00

(52) U.S. Cl. CPC H02J 7/0013; H02J 7/00032; H02J 7/0047; H02J 7/00714

(57) ABSTRACT

A method for charging a power supply device using a charging device, wherein the power supply device has a series of energy storage cells, as well as a control electronics system (CMS). A system for carrying out the charging method, wherein the system includes a power supply device and a charging device. The control electronics of the power supply device is designed to monitor currents and/or voltages of the power supply device and/or its energy storage cells, and to communicate with the charging device. Within the context of the charging method, an energy storage cell is selected, wherein a transition from a first charging phase to a second charging phase of the charging process is initiated on the basis of the voltage of the selected energy storage cell.

The invention relates to a method for charging an energy supply device by way of a charging device, wherein the energy supply device has a row of energy storage cells, and a control electronics unit (CMS). In a second aspect, the invention relates to a system for carrying out the charging method, wherein the system comprises an energy supply device and a charging device.

### BACKGROUND OF THE INVENTION

The invention lies in the technical field of the chargeable energy supply device. In the prior art, charging methods are known for chargeable energy supply devices of this kind, using which methods, however, the energy supply device cannot be charged in an optimum manner in many situations. In other words, a fill level is reached that could be higher with an optimum refinement of the charging method.

Upon delivery of a new energy supply device, it can usually be charged with a full capacity of 100%. Reference is made to a 100% state of charge (SOC) of the energy supply device. Aging phenomena appear over time, however, and there can be a reduction in the charging capacity of the energy supply device on account of the energy supply device not being charged in an appropriate manner. This reduces what is known as the state of health (SOH) of the energy supply device. A present state of health of an energy supply device that is no longer new can be determined, for example, by relating the full capacity of the energy supply device that is no longer new and the full capacity of the energy supply device in the new or delivery state to one another.

### SUMMARY OF THE INVENTION

In conventional charging methods, as are known from the prior art, the charging method can disadvantageously come to an end even though not all of the energy storage cells of the energy supply device have been fully charged yet. This can occur in particular when the energy storage cells of the energy supply device have unequal states of charge or charge histories. An undesired premature end of the charging method often occurs when one of the cells, in comparison with the other cells of the energy supply device, has such a high voltage that further charging has to be prevented. Such a situation can occur in particular with relatively old energy supply devices.

It is an object of the present invention to overcome the above-described shortcomings and disadvantages of the prior art and to provide an improved charging method and a corresponding system made up of an energy supply device and a charging device for carrying out the charging method. Another alternate or additional aim of the invention is to enable a higher fill level of the energy supply device after completion of the charging method than is currently possible in the prior art.

The present invention provides a method for charging an energy supply device by way of a charging device, wherein the energy supply device has a row of energy storage cells, and a control electronics unit. The method is characterized by the following method steps:
a) connecting the energy supply device to the charging device in order to charge the energy supply device,
b) starting the charging process in a first charging phase,
c) determining a selected energy storage cell by way of the control electronics unit of the energy supply device on the basis of a voltage of the energy storage cells,
d) ascertaining a charging current for the energy supply device by way of the control electronics unit on the basis of the voltage of the previously selected energy storage cells,
e) transmitting the previously ascertained charging current from the control electronics unit to the charging device,
f) charging the energy supply device with the previously ascertained charging current in the first charging phase, and
g) transitioning from the first charging phase to a second charging phase of the charging process when a maximum voltage of one of the energy storage cells has been reached.

In this case, the transition from the first charging phase to the second charging phase is initiated by a control command of the control electronics unit of the energy supply device to the charging device.

The method makes it possible to charge the individual energy storage cells (“cells”) of the energy supply device to a relatively high fill level. This makes it possible to considerably increase the amount of energy that is transferred to the energy supply device by a charging process, with the result that the working range of the energy supply device advantageously increases. The energy supply device can preferably be used in a power tool in order to supply the power tool with electrical energy. If, for each charging process, more energy is available in the energy supply device, the period of time between the individual charging processes advantageously increases and the work with the power tool can be carried out in a way that is much more efficient and time-saving. The invention in particular allows the energy supply device to be charged at least up to a maximum capacity of the weakest cells. In the context of the invention, it is preferred for the energy storage cell that has the lowest, that is to say the smallest, voltage at the beginning of the first charging phase of the charging process to be considered to be the “weakest energy storage cell”. As a result, the fill level of the energy supply device that is higher than conventional charging methods is advantageously reached.

In the context of the invention, it is preferred to consider the energy storage cell with the lowest voltage in the first charging phase of the charging method. If an energy storage cell has been very deeply discharged, it can preferably be charged with a reduced electric current. The weakest energy storage cell can, for example, be that energy storage cell that can store or take up the least amount of charge.

It has been shown that the transition from the first charging phase to the second charging phase can be effected particularly simply if the control electronics unit of the energy supply device transmits a control command for the changeover to the charging device. As a result, the energy supply device can advantageously assume control over the charging device and the charging process. Furthermore, it is therefore not required for the charging device to know the individual voltages and/or threshold values of the individual energy storage cells of the energy supply device. The voltages of the energy storage cells of the energy supply device are preferably ascertained independently of the method, such that they are already available in the energy supply device. In the context of the invention, the energy supply device can decide to keep the charging voltage substantially constant from a determined threshold value at an energy storage cell. The second charging phase preferably begins with the charging voltage being kept constant in this way. The invention is associated with the advantage that different types of energy supply devices can be charged using the charging device. In this case, it is possible for the changeover between the individual phases of the charging process to take place individually for the different types of energy supply devices, that is to say depending on the ascertained voltages of the energy storage cells within the respective energy supply device. As a result, depending on the cell type, different threshold values can be implemented for the individual cell voltage. The control electronics unit of the energy supply device can be formed by what is known as a cell management system (CMS). The control electronics unit is part of the energy supply device and has different functionalities. By way of example, the control electronics unit of the energy supply device is configured to monitor currents and/or voltages of the energy supply device and/or the energy storage cells thereof. To this end, the control electronics unit of the energy supply device can have corresponding sensors or measurement points that detect the currents and/or voltages of the individual cells or of the energy supply device as a whole. This detection can be carried out substantially continuously or at a determined, for example predefined, measurement frequency. The detected current and/or voltage data can be recorded and/or stored, wherein the energy supply device can preferably have a data memory for this purpose. The detected current and/or voltage data can in particular be used to determine a weakest energy storage cell of the energy supply device on the basis of the voltages of the energy storage cells. In other words, the control electronics unit of the energy supply device is capable of determining a weakest energy storage cell of the energy supply device on the basis of the voltages of the energy storage cells. In the context of the invention, it is very particularly preferred for the control electronics unit of the energy supply device, in the first charging phase of the charging process, to define the cell that has the lowest voltage at the beginning of the first charging phase as the “weakest cell”.

In the context of the invention, it is preferred for an empty energy storage cell to be characterized by a low voltage, whereas a full energy storage cell is characterized by a high voltage. In the context of the present invention, it is preferred for the voltage of the individual cells to be monitored at regular intervals, wherein typical query intervals can be 100 milliseconds (ms), for example. This regular monitoring has proven to be particularly expedient especially when the voltage of the energy storage cells is at a lower and/or an upper end of the permissible range.

The invention is based on the fundamental concept of orienting the charging method to the needs and requirements of the weakest energy storage cell of the energy supply device. This weakest energy storage cell is determined in the course of the method. The inventors have recognized that when charging an energy supply device, a higher fill level can therefore be reached than in the case of conventional charging methods as are known from the prior art. Depending on the charging phase of the charging process, different energy storage cells of the energy supply device can be determined to be the “weakest cell”, wherein the determination is carried out on the basis of the voltage of the energy storage cells. In the context of the invention, it can also be preferred for one and the same cell to be considered to be the weakest cell in both charging phases if the voltage ratios in the energy supply device are equal. In this case, the one cell has the lowest voltage among the cells at the beginning of the first charging phase of the charging process and the highest voltage among the energy storage cells of the energy supply device at the beginning of the second charging phase.

If, when monitoring the voltages of the energy storage cells of the energy supply device, a cell is noticeable, which has a different voltage in comparison with the other cells, the control electronics unit of the energy supply device thus considers this cell to be the “weakest cell” in the context of the invention. At the beginning of the first charging phase of the charging process, the cell that has the lowest voltage and therefore the lowest fill level can be considered to be the “weakest cell” in the context of the invention. In the context of the invention, it is preferred for the cell with the lowest state of health (SOH) to have, at the end of the discharge thereof, the lowest voltage among the energy storage cells of the energy supply device. During the charging process, this “weakest cell” is preferably characterized in that it has the greatest voltage increase. In the context of the invention, it is preferred for this “weakest cell” to also have the highest voltage among the energy storage cells of the energy supply device at the end of the charging process.

In addition, the control electronics unit of the energy supply device is capable of communicating with the charging device. There can preferably be a communication connection between the energy supply device and the charging device, via which communication connection current data, voltage data and/or control commands can be exchanged between the energy supply device and the charging device. The communication connection can be wired or wireless, wherein wired communication between the energy supply device and the charging device is preferred in the context of the invention. By way of example, the control electronics unit of the energy supply device can send a query to the charging device so as to discover a current value of the energy supply device. By way of example, the control electronics unit of the energy supply device can enquire about a total current that flows from the charging device into the energy supply device during the charging process. In the context of the invention, it is preferred for this total current, in the case of cells connected in parallel, to be split across the individual lines of the energy supply device.

In an alternative configuration of the invention, the control electronics unit of the energy supply device can ascertain the current value of the energy supply device by means of its own measurements.

The content of a control command that is exchanged between the energy supply device and the charging device can be, for example, that the control electronics unit of the energy supply device instructs the charging device to end the charging process. This control command from the control electronics unit of the energy supply device to the charging device is sent in particular when a minimum current of one of the energy storage cells of the energy supply device is reached. In the context of the invention, however, it can also be preferred for only the total current introduced above to be measured and transmitted. In addition, a control command is transmitted from the control electronics unit of the energy supply device to the charging device when the charging process should transition from a first charging phase to a second charging phase. In other words, the control electronics unit of the energy supply device is configured to effect a transition from a first charging phase to a second charging phase of the charging process when a maximum voltage of the weakest energy storage cell has been reached. The first charging phase of the charging process is preferably characterized in that the charging current is substantially constant, whereas in the second charging phase of the charging process, a charging voltage is substantially constant. The wording “substantially constant” does not represent unclear wording for a person skilled in the art because a person skilled in the art knows that this wording is not only intended to include mathematically exactly equal current or voltage values, but also slight deviations or variations, for example in a range of +/−5%. In the context of the invention, it is preferred for the charging voltage to correspond to the maximum voltage of the weakest energy storage cell.

In the first charging phase, the energy supply device or the control electronics unit thereof preferably defines the charging current in accordance with the selected or weakest energy storage cell or the voltage thereof and in a manner optimized for this selected and/or weakest energy storage cell of the energy supply device. In this context, the charging current for the energy supply device can be ascertained on the basis of the voltage of the weakest energy storage cell, wherein this ascertainment of the charging current is carried out by the control electronics unit of the energy supply device.

In particular, the charging current is ascertained on account of the voltage of the energy storage cells of the energy supply device. In this case, the lowest cell voltage, that is to say the voltage of the “weakest cell”, preferably determines the charging current with which the energy supply device is charged or with which the energy supply device may be charged so as not to damage the energy storage cells. Where individual cells have been very deeply discharged, it is preferred in the context of the invention for these cells in particular to be subjected to particularly gentle initial charging. On account of the voltages, detected using the control electronics unit of the energy supply device, of the energy storage cells, a corresponding charging current can be required from the charging device. The charging device is preferably configured to set and provide the charging current required by the energy supply device.

The charging current ascertained by the control electronics unit of the energy supply device can then be transmitted to the charging device. In the context of the invention, it is very particularly preferred for the charging current to be kept substantially constant in the first charging phase of the charging process, wherein the charging current preferably corresponds to a maximum current value of the weakest cell.

If the voltage maximum for a first cell of the energy supply device is reached, the charging phase changes or the charging process transitions from the first charging phase to the second charging phase. In the context of the invention, this transition from the first to the second charging phase can also preferably be referred to as changeover. In the second charging phase, the voltage is preferably kept substantially constant. In the context of the invention, it is preferred for the energy storage cells of the energy supply device to be connected in series (series connection) such that the voltages of the energy storage cells are preferably added together. The voltage of the cells can preferably be kept constant by maintaining a total voltage value at which a first cell of the energy supply device reaches its voltage maximum. In the context of the invention, it is preferred for the voltages of the individual energy storage cells to no longer change substantially if the total voltage of the energy supply device remains substantially constant.

In the context of the invention, it is preferred, in the second charging phase of the charging process, to consider the energy storage cell with the highest voltage to be the weakest energy storage cell. This can also be the same cell that was also considered to be the weakest cell in the first charging phase of the charging process. In the context of the invention, it is preferred for that cell that can store the least energy to be the first cell to be substantially empty during discharging, wherein an empty cell preferably has a very low voltage. During charging, this cell preferably is the first cell to reach a “full” fill level or charging state. As a result, it preferably has a higher voltage than the other cells. The changeover to the second charging phase can preferably be achieved by keeping the voltage of the charging device substantially constant from the transition from the first to the second charging phase. This can be communicated by the energy supply device to the charging device via a communication connection, for example. The changeover point between the first and the second charging phase of the charging process can preferably be at n times the maximum cell voltage, wherein “n” is the number of energy storage cells in the energy supply device. This value preferably corresponds to a measured value of the sum of all the individual cell voltages. The changeover point between the first and the second charging phase of the charging process can preferably be selected such that it is at the measured value of the total voltage at the connections of the energy supply device. The measurement time is preferably the time at which the energy storage cell with the maximum voltage reaches its specified charging voltage. In the second charging phase, the energy supply device is preferably charged in a voltage regulating mode. In the case of greatly differing cell voltages, it can be preferred in the context of the invention for the transition between the first and the second charging phase of the charging process, that is to say the changeover between the different regulating modes, to take place earlier.

The control electronics unit of the energy supply device transmits, when the voltage maximum is reached for a first cell of the energy supply device, a control command to the charging device so that the charging device accordingly regulates, adjusts or sets the currents and/or voltages. In the context of the invention, it is preferred for the transition from the first charging phase to the second charging phase to be initiated by a control command of the control electronics unit of the energy supply device to the charging device. The control electronics unit of the energy supply device in particular transmits a control command for regulating the charging current to the charging device, wherein, during the transition from the first charging phase to the second charging phase of the charging process, there is a changeover from a charging phase with substantially constant charging current to a charging phase with substantially constant charging voltage.

In the context of the invention, it is preferred for the charging process to be ended when a minimum current of one of the energy storage cells of the energy supply device is reached. The charging process can be ended by the control electronics units of the energy supply device in particular when a total charging current of the energy supply device is reached. The control electronics unit of the energy supply device then transmits a corresponding control command to the charging device. The energy supply device can then be removed from the charging device or decoupled from the charging device and for example can be connected to a power tool in order to supply the power tool with electrical energy during operation thereof.

In the context of the invention, it is preferred for a voltage of the energy storage cells and/or of the energy supply device to be monitored by the control electronics unit of the energy supply device. This preferably makes it possible to establish when the maximum voltage of an energy storage cell has been reached.

In the context of the invention, it is preferred for the energy supply device to be charged with a first substantially constant partial charging current and with a second substantially constant partial charging current in the first charging phase. In other words, the first charging phase can be divided into, for example, two partial charging phases, wherein each partial charging phase is characterized by a separate partial charging current. The second partial charging current can preferably be higher or greater than the first partial charging current. The first partial charging phase with the lower first partial charging current can preferably be referred to as initial charging, whereas the energy supply device, following this, can be charged further with the second partial charging current in the second partial charging phase.

In addition, the value of the constant charging current in the first charging phase can also be adjusted on account of temperature changes. This adjustment can preferably take place in stages, wherein the value of the charging current generally remains constant for a relatively long time following a change.

Current and/or voltage data can preferably be exchanged between the energy supply device and the charging device, wherein absolute and/or relative current and/or voltage values can be exchanged between the energy supply device and the charging device in the course of the charging method. In the context of the invention, this preferably means that absolute current values, such as 1 amp (A), 4.05 A or 2.33 A, and/or absolute voltage values, such as 1 volt (V), 4.05 V or 2.33 V, can be transmitted from the energy supply device to the charging device. Alternatively or additionally, it is however also possible for relative current and/or voltage values to be exchanged between the energy supply device and the charging device. In the context of the invention, this preferably means that the current and/or voltage values are indicated in relation to a reference value, for example a nominal voltage or a predefined current value. The relative current and/or voltage values can be indicated as a percentage (%) or as a proportion, for example.

In the context of the invention, it is preferred for a temperature of the energy supply device to also be monitored by the control electronics unit of the energy supply device.

The control electronics unit of the energy supply device is therefore configured to also monitor the temperature of the energy supply device or the energy storage cells thereof in addition to current and voltage of the energy supply device or the energy storage cells thereof. This makes it possible to ensure that the temperature of the energy supply device is in the range provided therefor so that overheating of or heat damage to the energy supply device is effectively avoided.

In a second aspect, the invention relates to a system that comprises an energy supply device and a charging device for charging the energy supply device, wherein the energy supply device has a row of energy storage cells, and a control electronics unit. The system is characterized in that the control electronics unit of the energy supply device is configured to monitor currents and/or voltages of the energy supply device and/or the energy storage cells thereof, and to communicate with the charging device in the sense that current data, voltage data and/or control commands are exchanged between the energy supply device and the charging device. In addition, the control electronics unit of the energy supply device is configured to determine a selected energy storage cell of the energy supply device on the basis of the voltages of the energy storage cells and to effect a transition from a first charging phase to a second charging phase of the charging process when a maximum voltage of one of the energy storage cells has been reached. The control electronics unit is configured to ascertain the charging current for the energy supply device on the basis of a voltage of the previously selected energy storage cell and to transmit the charging current thus ascertained to the charging device, wherein the energy supply device is charged with the previously ascertained charging current in the first charging phase, wherein the control electronics unit of the energy supply device is furthermore configured to transmit a control command for the transition from the first charging phase to the second charging phase to the charging device. The definitions, technical effects and advantages described for the charging method apply analogously to the system made up of the energy supply device and the charging device. In particular, the system is configured to carry out the charging method above. Therefore, the system can be referred to as “system for carrying out the charging method”. In the context of the invention, determining a selected energy storage cell on the basis of the voltage of the different energy storage cells within the energy supply device is preferably also referred to as “selecting an energy storage cell”.

In the context of the invention, it is preferred for the energy storage cell with the lowest voltage at the beginning of the first charging phase of the charging process to be considered to be the weakest energy storage cell, whereas in the second charging phase, the energy storage cell that has the highest voltage is referred to as the weakest cell. In addition, the control electronics unit of the energy supply device is configured to end the charging process of the energy supply device when a minimum current of one of the energy storage cells of the energy supply device is reached. The energy supply device and the charging device can exchange current data, voltage data and/or control commands, wherein control commands are transmitted in particular from the control electronics unit of the energy supply device to the charging device. By way of example, the control electronics unit of the energy supply device transmits a control command for the transition from the first charging phase to the second charging phase to the charging device. The control electronics unit of the energy supply device can also be configured to monitor a temperature of the energy supply device in order to ensure that the cells of the energy supply device are always in a temperature range permitted for them. To detect the temperature, the energy supply device can comprise appropriate sensors and evaluation units. The energy supply device can preferably interrupt the charging process if the energy supply device detects that one of the cells or the energy supply device as a whole has a temperature outside of the permitted temperature range. To this end, the control electronics unit of the energy supply device can transmit a corresponding control command to the charging device. In the context of the invention, it is preferred for the charging current to be substantially constant in the first charging phase of the charging process, and for a charging voltage to be substantially constant in the second charging phase of the charging process.

### BRIEF DESCRIPTION OF THE DRAWINGS

Further advantages will become apparent from the following description of the figures. An exemplary embodiment of the present invention is shown in the figures. The figures, the description and the claims contain numerous features in combination. A person skilled in the art will expediently also consider the features individually and combine them to produce useful further combinations.

Identical and similar components are denoted by the same reference signs in the figures, in which:

FIG. 1 shows a schematic view of a power tool with a preferred configuration of the energy supply device of the system; and

FIG. 2 shows a schematic view of a preferred configuration of the system.

### DETAILED DESCRIPTION

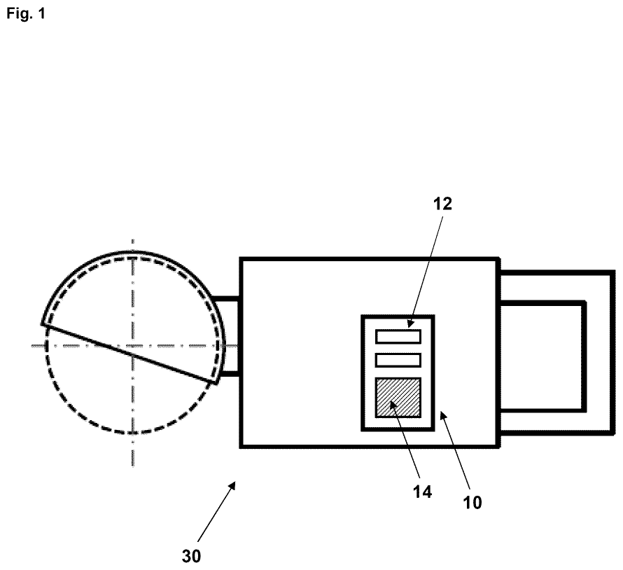

FIG. 1 shows a schematic view of a power tool 30 with an energy supply device 10. The power tool 30 can be a cut-off grinder, for example, which has a cut-off wheel as a tool. The power tool 30 can have a grip which is designed, for example, as a rear handle. In addition, the power tool 30 can have operating elements, such as switches or buttons, in a manner known per se. Furthermore, the power tool 30 can have a motor, which can represent a load and can be supplied with electrical energy by the energy supply device 10. The energy supply device 10 that is depicted in FIG. 1 has two energy storage cells 12 in the schematic exemplary embodiment shown. In addition, the energy supply device 10 shown in FIG. 1 comprises a control electronics unit 14.

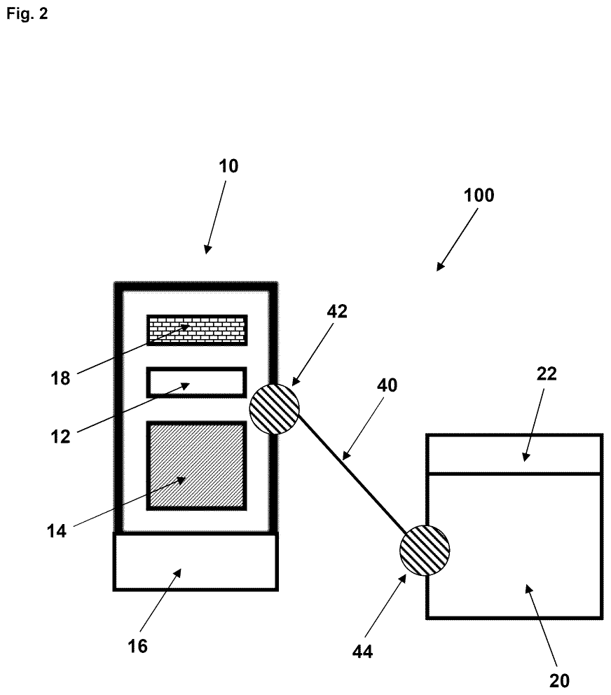

FIG. 2 shows a schematic view of a preferred configuration of the system 100 made up of an energy supply device 10 and a charging device 20. The energy supply device 10 can be connected to the charging device 20 in order to be charged. To this end, an interface 16, 22 can be provided, wherein the energy supply device 10 and the charging device 20 can be connected to one another via the respective interface partners 16, 22. In the exemplary embodiment shown in FIG. 2, the energy supply device 10 has two energy storage cells 12, wherein one of the energy storage cells 12 represents the weakest energy storage cell 18 of the energy supply device 10. The energy supply device 10 can of course comprise more than two energy storage cells 12, for example five, six, eight, ten, twelve or eighteen energy storage cells 12. In addition, the energy supply device 10 has a control electronics unit 14. The energy supply device 10 can communicate with the charging device 20 via a communication connection 40, that is to say can exchange current data, voltage data and/or control commands. To this end, the energy supply device 10 and the charging device 20 can have communication modules 42, 44. The communication module 42 of the energy supply device 10 can—as shown in FIG. 2—be part of the energy supply device 10. However, it can also be preferred in the context of the invention for the communication module 42 of the energy supply device 10 to be part of the control electronics unit 14 of the energy supply device 10.

### LIST OF REFERENCE SIGNS

10 Energy supply device
12 Energy storage cells
14 Control electronics unit
16 Interface of the energy supply device
18 Weakest energy storage cell
20 Charging device
22 Interface of the charging device
30 Power tool
40 Communication connection between the energy supply device and the charging device
42 Communication module of the energy supply device
44 Communication module of the charging device
100 System

What is claimed is:

1-13. (canceled)

14. A method for charging an energy supply device by way of a charging device, wherein the energy supply device has a row of energy storage cells, and a control electronics unit, the method comprising the following steps:
a) connecting the energy supply device to the charging device in order to charge the energy supply device;
b) starting the charging process in a first charging phase;
c) determining a selected energy storage cell by way of the control electronics unit of the energy supply device on the basis of a voltage of the energy storage cell;
d) ascertaining a charging current for the energy supply device by way of the control electronics unit on the basis of a voltage of the previously selected energy storage cell;
e) transmitting the previously ascertained charging current from the control electronics unit to the charging device;
f) charging the energy supply device with the previously ascertained charging current in the first charging phase; and
g) transitioning from the first charging phase to a second charging phase of the charging process when a maximum voltage of an energy storage cell has been reached;
wherein the transition from the first charging phase to the second charging phase is initiated by a control command of the control electronics unit of the energy supply device to the charging device.

15. The method as recited in claim 15 wherein the charging process is ended when a minimum current of one of the energy storage cells of the energy supply device is reached.

16. The method as recited in claim 15 wherein a voltage or a current of the energy storage cells or of the energy supply device is monitored by the control electronics unit of the energy supply device.

17. The method as recited in claim 15 wherein current or voltage data are exchanged between the energy supply device and the charging device.

18. The method as recited in claim 15 wherein the charging current is substantially constant in the first charging phase of the charging process, and in that a charging voltage is substantially constant in the second charging phase of the charging process.

19. The method as recited in claim 15 wherein absolute or relative current or voltage values are exchanged between the energy supply device and the charging device in the course of the method.

20. The method as recited in claim 15 wherein a temperature of the energy supply device is also monitored by the control electronics unit of the energy supply device.

21. A system comprising:
an energy supply device; and
a charging device for charging the energy supply device, wherein the energy supply device has a row of energy storage cells, and a control electronics unit, the control electronics unit being configured to monitor currents or voltages of the energy supply device or the energy storage cells, and to communicate with the charging device in the sense that current data, voltage data or control commands are exchanged between the energy supply device and the charging device, wherein the control electronics unit of the energy supply device is furthermore configured to determine a selected energy storage cell of the energy supply device on the basis of the voltages of the energy storage cells and to effect a transition from a first charging phase to a second charging phase of the charging process when a maximum voltage of one of the energy storage cells has been reached, wherein the control electronics unit is configured to ascertain the charging current for the energy supply device on the basis of a voltage of the previously selected energy storage cell and to transmit the charging current thus ascertained to the charging device, wherein the energy supply device is charged with the previously ascertained charging current in the first charging phase, wherein the control electronics unit of the energy supply device is configured to transmit a control command for the transition from the first charging phase to the second charging phase to the charging device.

22. The system as recited in claim 21 wherein at the beginning of the first charging phase, the energy storage cell with the lowest voltage is considered to be the weakest energy storage cell, and in that, at the beginning of the second charging phase, the energy storage cell with the highest voltage is considered to be the weakest energy storage cell.

23. The system as recited in claim 21 wherein the control electronics unit of the energy supply device is configured to end the charging process of the energy supply device when a minimum current of one of the energy storage cells of the energy supply device is reached.

24. The system as recited in claim 21 wherein the energy supply device and the charging device are configured to exchange current or voltage data.

25. The system as recited in claim 21 wherein the control electronics unit of the energy supply device is configured to monitor a temperature of the energy supply device.

26. The system as recited in claim 21 wherein the charging current is substantially constant in the first charging phase of the charging process, and in that a charging voltage is substantially constant in the second charging phase of the charging process.
